(19) United States
(12) Patent Application Publication
(10) Pub. No.: US 2020/0357289 A1
(43) Pub. Date: Nov. 12, 2020

(54) METHOD AND SYSTEM FOR UPDATING A PILOT SITUATIONAL AWARENESS SYSTEM

(71) Applicant: SAAB AB, Linkoeping (SE)

(72) Inventor: Stefan BLOM, Saltsjoebaden (SE)

(21) Appl. No.: 16/962,699

(22) PCT Filed: Jan. 25, 2018
(86) PCT No.: PCT/SE2018/050059

§ 371 Date: Jul. 16, 2020

(51) Int. Cl. G08G 5/00; G06F 16/23

(52) U.S. Cl. CPC G08G 5/0047; G08G 5/0013; G06F 16/2379

(57) ABSTRACT

The present disclosure relates to a method (300) for updating a pilot situational awareness system. The method comprises the step of providing (310) sensor data from at least one non-ranging sensor aboard an aircraft for which the pilot situational awareness system is used. The method further comprises the step of updating (360) a database of the pilot situational awareness system based on the provided sensor data. The present disclosure further relates to a system for updating a pilot situational awareness system, to an aircraft, to a computer program product, and to a computer-readable storage medium.

### TECHNICAL FIELD

The present disclosure relates to a method and a system for updating a pilot situational awareness system. The present disclosure further relates to an aircraft, to a computer program product, and to a computer-readable storage medium.

### BACKGROUND ART

Aircrafts of today are often equipped with pilot situational awareness systems, such as a synthetic vision system, SVS, a synthetic vision guidance system, SVGS, and/or a terrain awareness warning system, TAWS. Such systems usually increase safety and allow operating the aircraft even under non-optimal weather conditions. Pilot situational awareness systems often receive their data from a database. For working properly, it is important that the data in the database is accurate.

However, the data in the database might be old and the surrounding might have been changed since the time the data for the database was provided. As an example, in relation to a TAWS new buildings might have been constructed and/or old buildings been destroyed so that the height information in the database for the TAWS no longer might be accurate.

There exist different ways of updating the data in a database of the pilot situational awareness system. One way is to manually update the data. This is often time consuming and requires knowledge of what to update. Thus, it will not cover unknown changes in the surrounding.

Another way is to rebuild the database, for example by rescanning the Earth or parts thereof by satellites. This will update the database, but is quite costly and time consuming as well. Also, although the data will be newer after the rebuild, the data might still be inaccurate at the time an aircraft operates since changes anyhow might have happened after the rebuilding.

Yet another way is to equip the aircraft which uses the pilot situational awareness system with ranging sensors, such as laser sensors for scanning the ground under the aircraft, and to update the database based on that. Although this usually will provide an up-to-date database, this is still costly as most aircrafts usually are not equipped with ranging sensors which have the possibility to provide data which allows an update of the database. Thus, other aircrafts which have this kind of sensors have to be used. It is hardly feasible to always first send another aircraft to look for possible outdated data prior operating the intended aircraft for which accurate data in the pilot situational awareness system is desired. Another possibility is to equip the intended aircraft with that kind of sensors. However, this adds complexity to the aircraft and increases the weight and thus the operating cost of the aircraft.

In summary, the above described solutions for updating databases of a pilot help system each have at least some drawbacks.

### SUMMARY OF THE INVENTION

It is an objective of the present disclosure to provide a method, a system, an aircraft, a computer program product, and a computer-readable storage medium which alleviate at least some of the drawbacks of prior-art solutions.

It is a further objective of the present disclosure to provide a method, a system, an aircraft, a computer program product, and a computer-readable storage medium which constitute an alternative to prior-art solutions.

At least some of the objectives are achieved by a method for updating a pilot situational awareness system. The method comprises the step of providing sensor data from at least one non-ranging sensor aboard an aircraft for which the pilot situational awareness system is used. The method further comprises the step of updating a database of the pilot situational awareness system based on the provided sensor data.

Many aircrafts are equipped by non-ranging sensors. Thus, by using non-ranging sensors to update the database, the database can be updated by the very same aircraft without the need to carry extra equipment. Thus, the database can be kept up-to-date on the fly. No extra aircrafts or satellites are needed for an updating. No extra weight has to be added to the aircraft. Thus, weight and space are saved. Thus, a more efficient method is achieved.

In one example, the pilot situational awareness system is any of a synthetic vision system, SVS, synthetic vision guidance system, SVGS, and/or terrain awareness warning system, TAWS. This allows using the method for some of the most commonly used pilot situational awareness systems and thus increases their accuracy.

In one example, the method further comprises the step of comparing the provided sensor data from the at least one non-ranging sensor with corresponding data from the pilot situational awareness system for finding differences between the data. The updating is only performed in case it is determined that the provided sensor data and the corresponding data from the pilot situational awareness system differ more than a pre-determined threshold. This reduces the requirements for computational power since the environment likely in most cases will not change.

In one example, the at least one non-ranging sensor is an imaging sensor. When aircrafts are equipped with imaging sensors, this allows to use the method for many aircrafts without any bigger needs of additional equipment.

In one example, the method further comprises the step of transmitting the provided sensor data to a processor arrangement external to the aircraft. The updating of the database of the pilot situational awareness system is performed at the external processor arrangement. This further reduces the need for any additional equipment at the aircraft since most aircrafts are equipped with transmitting devices. Updating of databases for pilot situational awareness systems can be quite complex. By performing that step outside the aircraft, there is thus no need for bigger computational power at the aircraft.

In one example, the method further comprises the step of transmitting an update of the database from the external processor arrangement to the aircraft. This allows using the updated database by the very same aircraft even in case the update itself is not performed at the aircraft.

In one example, the method further comprises the step of selecting the provided sensor data according to pre-determined conditions. The updating is only performed based on the selected sensor data. This further reduces complexity. The sensor data can be selected according to what is important for a current flight and/or a current mission. Thus, sensor data not considered important can be disregarded without the need to analyse it for differences to the database and/or to update the database based on it.

In one example, the updating of the pilot situational awareness system is performed in real-time or at least in nearly real-time. This increases the applicability of the method as it might be used in more contexts, such as for critical missions on the current flight.

At least some of the objectives are also achieved by a system for updating a pilot situational awareness system. The system comprises at least one non-ranging sensor. The at least one non-ranging sensor is arranged to provide sensor data. The at least one non-ranging sensor is situated aboard an aircraft for which the pilot situational awareness system is used. The system further comprises the pilot situational awareness system. The system even further comprises a processor arrangement which is arranged to update a database of the pilot situational awareness system based on the provided sensor data.

In one embodiment, the pilot situational awareness system is any of a synthetic vision system, SVS, synthetic vision guidance system, SVGS, and/or terrain awareness warning system, TAWS.

In one embodiment, the at least one non-ranging sensor is an imaging sensor.

In one embodiment, the processor arrangement is situated external to the aircraft. In this embodiment, the system further comprises a transmitter arrangement, which is arranged to transmit the provided sensor data to the external processor arrangement.

In one embodiment, the system further comprises a receiver arrangement aboard the aircraft. The receiver arrangement is arranged to receive an update of the database from the external processor arrangement.

At least some of the objectives are also achieved by a computer program product, comprising instructions which, when the program is executed by a computer, cause the computer to carry out the method according to the present disclosure.

At least some of the objectives are also achieved by a computer-readable storage medium comprising instructions which, when executed by a computer, cause the computer to carry out the method according to the present disclosure.

At least some of the objectives are also achieved by an aircraft which comprises the system according to the present disclosure.

In relation to this disclosure the term computer can relate to what is commonly referred to as a computer and/or to an electronic control unit.

The system, the aircraft, the computer program product and the computer-readable storage medium have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, an aircraft according to one embodiment of the present disclosure;

FIG. 2 shows, in a schematic way, a system for updating a pilot situational awareness system according to an embodiment of the present disclosure;

FIG. 3 shows, in a schematic way, a method according to an example of the present invention; and

FIG. 4 shows, in a schematic way, an example of a situation in which the present disclosure can be used.

### DETAILED DESCRIPTION

The term “link” refers herein to a communication link which may be a physical connection such as an opto-electronic communication line, or a′ non-physical connection such as a wireless connection, e.g. a radio link or microwave link.

The term “image” does not require a lifelike picture. Instead, the term “image” comprises also wrong-coloured images, stylised images, and the like.

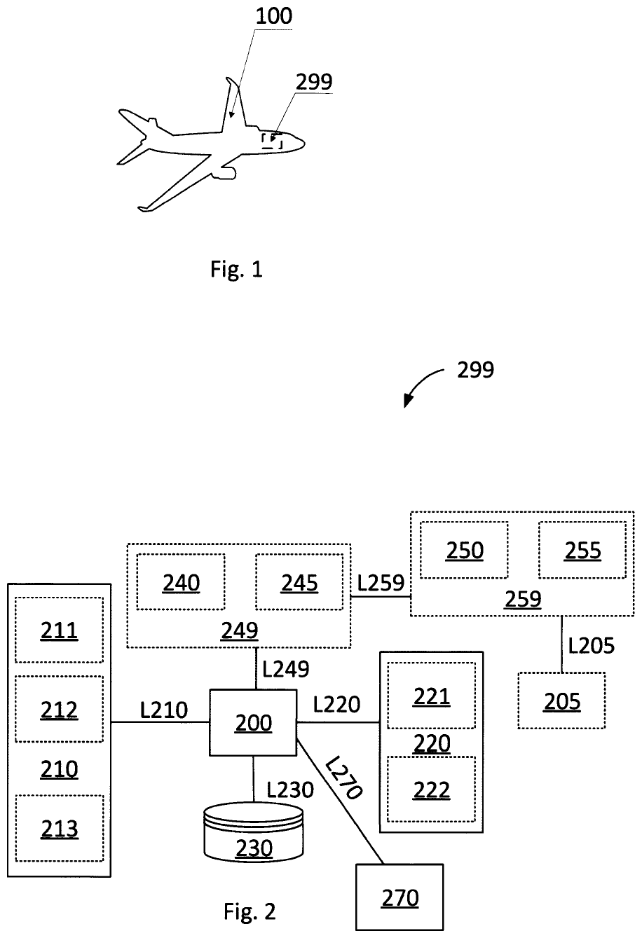

FIG. 1 shows, in a schematic way, an aircraft 100 according to one embodiment of the present disclosure. The aircraft 100 can be any kind of aircraft, such as an airplane, a helicopter, an airship, or the like. The aircraft 100 can be manned or unmanned. The aircraft can comprise a system 299 for updating a pilot situational awareness system, which is described in more detail in relation to FIG. 2.

FIG. 2 shows, in a schematic way, a system 299 for updating a pilot situational awareness system according to an embodiment of the present disclosure. The system 299 comprises the pilot situational awareness system 210. In one example, the pilot situational awareness system 210 comprises a synthetic vision system, SVS, 211. In one example, the pilot situational awareness system 210 comprises a synthetic vision guidance system 212, SVGS. In one example, the pilot situational awareness system 210 comprises a terrain awareness warning system 213, TAWS. The present disclosure can be applied to any other pilot situational awareness system. The present disclosure can be applied to any combination of different pilot situational awareness systems, such as a combination of the systems 211-213.

In the following, when further components are described in relation to the system 299, it should be understood that these components might partly or fully be part of the pilot situational awareness system 210. As an example, although the database 230 is depicted as a separate element, the database 230 might equally well be fully or partly integrated in the pilot situational awareness system 299.

The system 299 comprises a sensor array 220. The sensor array 220 comprises at least one non-ranging sensor. In a minimum configuration, the sensor array 220 is one non-ranging sensor. The at least one non-ranging sensor can be at least one imaging sensor. In one example, the sensor array 220 comprises at least one infrared sensor 221. The at least one infrared sensor 221 can be any kind of infrared sensors, IR sensors, such as a sensor for near infrared, NIR, a sensor for short-wavelength IR, a sensor for mid-wavelength IR, a sensor for long-wavelength IR, or, for example, any combination thereof. In one example, the sensor array 220 comprises a sensor for visible light 222. However, it should be emphasised that the current disclosure could be implemented with non-ranging sensors applying any other wavelength as well. The sensor array 220 and/or any sensor therein is arranged to provide sensor data. In one example the sensor data comprises images. It should be understood that the images can be provided in an electronic format, such as in a binary format. In one example, the sensor data comprises data relating to the surrounding of the aircraft. One example of sensor data is an image of the ground in the surrounding of the aircraft.

The term non-ranging relates to the fact that no direct information regarding a distance between the sensor and an obstacle, like the ground, is provided by the sensor(s). Examples of ranging sensors, i.e. of not non-ranging sensors, are LIDAR, radar, time-of-flight cameras, or the like. The sensor array 220 is situated aboard an aircraft for which the pilot situational awareness system is used. Herein, and throughout the whole description, the term “aboard” includes the possibility that an element is situated at the outside of the aircraft or the like, such as at the outside of the hull and/or a wing of the aircraft.

The system 299 can comprise a database 230. The database 230 can be part of the pilot situational awareness system 210. The database 230 can be external to the pilot situational awareness system 210. In one example, the database 230 is situated aboard the aircraft. In one example, the database 230 is situated external to the aircraft. Herein, and throughout the whole description, the term “external” relates to the fact that an object is not physically connected to another object. Thus, a database 230 external to the aircraft does not relate to a database at the outside of the aircraft, but to a database 230 completely physically disconnected from the aircraft, such as a database in a data centre on the ground, or the like. In one example, the database is partly aboard the aircraft and partly external to the aircraft. In one example, the database 230 is a distributed database, for example what is commonly referred to as “in the cloud”.

The database 230 can comprise data which is needed for the pilot situational awareness system 210, such as map data, surface elevation data, data regarding objects, way points, or any other data needed for the pilot situational awareness system 210, or any combination of the aforementioned data.

The system 299 further comprises a first processor arrangement 200. In one example, the first processor arrangement 200 comprises at least a first control unit, such as an electronic control unit, ECU. The first processor arrangement 200 can be connected to the sensor array 220 via a link L220. The sensor array 220 is arranged for communication with the first processor arrangement 200, for example via the link L220. The sensor arrangement 220 is arranged to transmit sensor data to the first processor arrangement 200. The first processor arrangement 200 is arranged to receive the sensor data from the sensor array 220. In one example, the first processor arrangement 200 is part of the pilot situational awareness system 210. In one example, the first processor arrangement 200 is not part of the pilot situational awareness system 210.

The first processor arrangement 200 is arranged to update the database based on the provided sensor data. This is described in further detail later on. The first processor arrangement 200 can be connected to the database 230 via a link L230. The database 230 is arranged for communication with the first processor arrangement 200, for example via the link L230. The first processor arrangement 200 can be arranged to receive data from the database 230. The first processor arrangement 200 can be arranged to process data from the database 230 and/or the sensor array 220. The first processor arrangement 200 can be arranged to transmit data to the database 230, such as the processed data. The processed data may comprise an update of the database.

The system 299 can comprise a first transceiver arrangement 249. The system 299 can comprise a first transmitter arrangement 240. In one example, the first transmitter arrangement 240 is part of the first transceiver arrangement 249. The first processor arrangement 200 can be connected to the first transceiver arrangement 249 and/or the first transmitter arrangement 240 via a link 1240. The first processor arrangement 200 is arranged for communication with the first transmitter and/or the first transceiver arrangement 240, 249, for example via the link L249. The first processor arrangement can be arranged to transmit data to the first transmitter and/or the first transceiver arrangement 240, 249, for example sensor data, such as sensor data received from the sensor array 220, and/or data from the database 230.

The first transmitter and/or the first transceiver arrangement 240, 249 can be arranged to transmit data to an object external to the aircraft, for example to a receiver external to the aircraft, such as a receiver at another aircraft, at another vehicle, or at the ground.

A second processor arrangement 205 might be arranged for communication with the first processor arrangement 200 via at least one link, such as via the links L205, L259, and L249. It may be a processor arrangement external to the aircraft 100. It may be adapted to conducting the innovative method steps according to the invention. The second processor arrangement 205 may be arranged to perform the inventive method steps according to the invention. It may be arranged for communication with the first processor arrangement 200 via an internal network on board the aircraft. It may be adapted to performing substantially the same functions as the first processor arrangement 200, such as controlling any of the elements of the system 299. The innovative method may be conducted by the first processor arrangement 200 or the processor arrangement 205, or by both of them.

The system 299 can comprise a second transceiver arrangement 259. The system 299 can comprise a second receiver arrangement 255. In one example, the second receiver arrangement 255 is part of the second transceiver arrangement 259. The first transmitter and/or the first transceiver arrangement 240, 249 can be arranged to transmit data, such as sensor data origination from the sensor array 220, and/or such as data from the database 230, to the second transceiver arrangement 259 and/or the second receiver arrangement 255, for example via a link L259. The second transceiver arrangement 259 and/or the second receiver arrangement 255 can be arranged to receive the transmitted data from the first transmitter and/or the first transceiver arrangement 240, 249. The second transceiver arrangement 259 and/or the second receiver arrangement 255 can be arranged external to the aircraft 200, such as on another aircraft, at another vehicle, or at the ground.

The second processor arrangement 205 can be connected to the second transceiver arrangement 259 and/or the second receiving arrangement 255 via a link L205. The second processor arrangement 205 is arranged for communication with the second receiver and/or the second transceiver arrangement 255, 259, for example via the link L205. The second processor arrangement can be arranged to receive data from the second receiver and/or the second transceiver arrangement 255, 259, for example sensor data, such as sensor data originating from the sensor array 220, and/or data from the database 230.

In FIG. 2 the database 230 is depicted as being mainly connected to the first processor arrangement 200. However, as already discussed above, the database 230 might be equally well partly or fully external to the aircraft. In one example, the database 230 is thus mainly connected to the second processor arrangement 205.

The system 299 can comprise a second transmitter arrangement 250. In one example, the second transmitter arrangement 250 is part of the second transceiver arrangement 259. The second processor arrangement 205 can be arranged to transmit data to the second transmitter and/or the second transceiver arrangement 250, 259, for example updated data from the database 230. The transmission can be performed via the link L205.

The system 299 can comprise a first receiver arrangement 245. In one example, the first receiver arrangement 245 is part of the first transceiver arrangement 249. The second transmitter and/or the second transceiver arrangement 250, 259 can be arranged to transmit data, such as updated data from the database 230, to the first transceiver arrangement 249 and/or the first receiver arrangement 245, for example via the link L259. The first transceiver arrangement 249 and/or the first receiver arrangement 255 can be arranged to receive the transmitted data from the second transmitter and/or the second transceiver arrangement 250, 245. The first transceiver arrangement 249 and/or the first receiver arrangement 255 can be arranged to transmit the received data, such as to the first processor arrangement, to the database 230, and/or to the pilot situational awareness system.

The system 299 can comprise a means for determining the position of the aircraft. In one example, these means comprise a receiver for a global navigation satellite system, GNSS-receiver 270. As an example, the GNSS-receiver 270 can comprise a GPS-receiver, a receiver for GLONASS, a receiver for Galileo, and/or any other receiver for a GNSS. The means for determining the positions of the aircraft are arranged to determine the position of the aircraft, preferably in three dimensions. In one example, the position of the aircraft is determined by the GNSS-receiver 270.

The GNSS-receiver 270 can be arranged to transmit information to the first processor arrangement 200, for example via a link L270. As an example, the GNSS-receiver 270 might be arranged to transmit the position of the aircraft to the first processor arrangement 200. The first processor arrangement 200 can be arranged to receive information from the GNSS-receiver 270.

In one example, the position of the aircraft is determined by the first processor arrangement 200, for example based on information received from the GNSS-receiver. It should, however, be emphasised that the position of the aircraft might be determined in any other way as well. As an example, the position of the airplane can be determined by an external radar system or any other external system. The externally determined position of the airplane might then be transferred to the airplane, for example by a transmitting device.

The first processor arrangement 200 can be arranged to update the database further based on the determined position of the aircraft. The pilot situational awareness system 210 and/or the database might be arranged to provide data, for example to the first processor arrangement 200. The provided data might correspond to the provided sensor data. The first processor arrangement 200 might be arranged to compare the provided sensor data from the at least one non-ranging sensor with the corresponding data from the pilot situational awareness system for finding differences between the data. The first processor arrangement 200 might be arranged to perform the updating only in case it is determined that the provided sensor data and the corresponding data from the pilot situational awareness system differ more than a pre-determined threshold.

The first processor arrangement 200 might be arranged to select the provided sensor data according to pre-determined conditions. The first processor arrangement 200 might be arranged to perform the updating only based on the selected sensor data.

The first processor arrangement 200 might be arranged to perform the updating of the pilot situational awareness system in real-time or at least in nearly real-time. Herein, the term real-time or nearly real-time relates to the fact that the updated data can be used during the ongoing flight and/or mission. Thus, even an updating which takes a few seconds might typically be considered to be at least nearly real-time as such a delay in a pilot situational awareness system usually is not critical. As an example, a pilot intending to land on a runway will typically receive a representation of the runway already several minutes prior the landing. In case it takes, for example, five seconds to update the pilot situational awareness system with a new object in the way between the aircraft and the runway, this will still give enough of time for the pilot to react on this new object in the updated pilot situational awareness system.

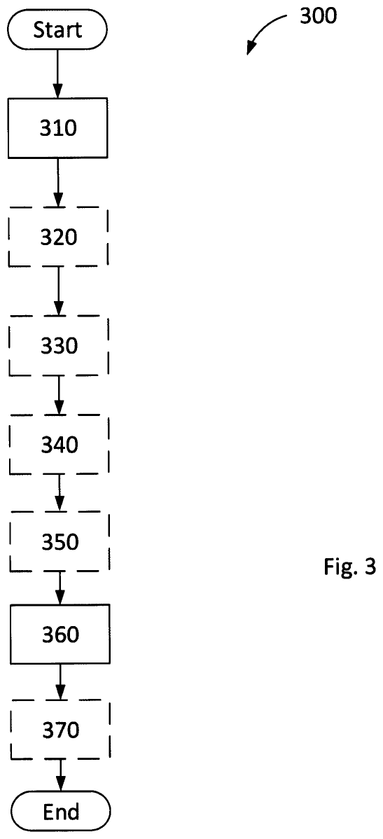

The functioning of the updating-process will be explained in further detail in relation to FIG. 3. It should be emphasised that the system 299 can be arranged to perform any of the method steps described in relation to FIG. 3. Especially, specific components of the system 299 can be arranged to perform method steps described in relation to FIG. 3. Likewise, the method described in relation to FIG. 3 can further comprise steps which are described in relation to FIG. 2. Especially, features attributed to the system 299 or any of the components thereof, especially features for which the system 299 or any of the components are arranged, can be comprised in the method described in relation to FIG. 3.

FIG. 3 shows, in a schematic way, a method 300 according to an example of the present invention. The method 300 is a method for updating a pilot situational awareness system. The pilot situational awareness system can, for example, be a synthetic vision system, SVS, a synthetic vision guidance system, SVGS, and/or a terrain awareness warning system, TAWS. The method starts with step 310.

Step 310 comprises providing sensor data from at least one non-ranging sensor aboard an aircraft for which the pilot situational awareness system is used. In one example, the non-ranging sensor is an imaging sensor. This has been further explained above in relation to FIG. 2. The sensor data can, for example, relate to images from the at least one non-ranging sensor, such as images from the surrounding of the aircraft. The method continues with the optional step 320.

The optional step 320 comprises selecting the provided sensor data according to pre-determined conditions. In one example, the pre-determined conditions relate to specific areas of the surrounding of the aircraft. As an example, sensor data is only selected in case it relates to a pre-determined area in the surrounding of the aircraft. As an example, in case it is determined that the aircraft should land in a specific area, it might be desirable to update the pilot situational awareness system for the specific area and possibly at some area around it. However, it might not be needed to update the pilot situational awareness system for areas which are, for example, tens or hundreds of kilometres away from the intended landing area since the aircraft there might be at high altitude so that no risk will occur there even in case the data is not updated there. In one example, the selecting refers to specific sensors and/or to specific wavelengths. As an example, it might be determined that only one, or a limited amount of sensors might be useful for potentially updating the pilot situational awareness system. Then only sensor data from the only one, or from the limited amount of sensors might be selected. Any other pre-determined conditions for selecting sensor data might be use as well. The method might then continue with only the selected sensor data. By performing a selection of sensor data the total amount of sensor data used in the remainder of the method might be drastically reduced, which in its turn can reduce the need for computational power and/or computation time. Selecting sensor data is generally much faster performed than an updating process of a database. Further, in case transmission is used, selecting the sensor data might reduce the needed bandwidth for transmission. The method continues with the optional step 330.

In the optional step 330 data is provided from the pilot situational awareness system. This might comprise providing data from a database. In one example, the provided data from the pilot situational awareness system corresponds to the provided sensor data. As an example, in case the provided and/or the selected sensor data corresponds to a specific area of the surrounding of the aircraft, the data provided from the pilot situational awareness system might correspond to data representing the same area. It is in general not necessary that the data from the pilot situational awareness system and from the sensor(s) were recorded at the same wavelength or the like, although this might be put as a constraint as well. The method continues with the optional step 340.

The optional step 340 comprises comparing the provided sensor data from the at least one non-ranging sensor with corresponding data from the pilot situational awareness system for finding differences between the data. As an example, data obtained in step 310 or step 320 is compared with data obtained in step 330 for finding differences. In one example, the difference relates partly or fully to surface elevation data. In one example, the difference relates partly of fully to the soil properties. Any other properties might be used as well for fully or partly representing the difference. It should be understood that the fact that, for example, differences in the surface elevation data are analysed does not require that data from ranging sensors have been used. As an example, in case an image at visible wavelength is provided from a sensor, it might be analysed whether that image is compatible with the data from the pilot situational awareness system. Such an analysis might comprise looking whether distortion of objects, such as buildings, roads, geological formations, or the like, in the visible image are compatible with the surface elevation data from the pilot situational awareness system. Finding of differences between sensor data from non-ranging sensors and between data from a pilot situational awareness might be a complex task and will not be described here any further. However, as an example, the company Vricon Systems AB has developed methods and systems for finding differences between images and models of the environment. This is, for example, described in more detail in EP 2 911 090 A1. These models of the environment can be used in pilot situational awareness systems. These methods and systems might, as an example, be used to perform step 340. In case no differences are found or in case the found differences are below a pre-determined threshold, the method is in one example aborted, restarted, and/or step 360 will not be performed. The term threshold might relate to a one-dimensional value or to a multi-dimensional quantity. As an example, the threshold might relate to the sum, a weighted sum, or an average value of deviations between data from the pilot awareness system and the provided sensor data. The deviations can relate to height differences, differences in distortion of objects, or the like. After step 340 the method continues with the optional step 350.

The optional step 350 comprises transmitting the provided sensor data to a processor arrangement external to the aircraft. The external processor arrangement can, for example, be situated at another aircraft, at another vehicle, or at the ground. By transmitting data to an external processor arrangement, the computational power for step 360 does not have to be provided aboard the aircraft. As an example, the computational power might be provided by an external data centre. This can save weight and energy consumption at the aircraft. Especially in case the aircraft is an unmanned aircraft, this might heavily contribute to saving energy, space and/or weight.

Step 350 might also be performed earlier, for example after step 310, after step 320, or after step 330. Step 350 might comprise transmitting the provided data from the pilot situational awareness system to the external processor arrangement. When performing step 350 prior step 340 even the computational power for performing step 340 might be saved at the aircraft, and thus space, weight and/or energy at the aircraft. Depending on when step 350 is performed, more or less bandwidth might be required between the aircraft and the external processor arrangement. In practice, a person skilled in the art will realise that there might be a trade-off between bandwidth requirements and space, weight, energy and/or computational power requirements aboard the aircraft. Thus, a person skilled in the art will realise that the time the optional step 350 is performed might help to improve in a given situation one or more parameters among bandwidth, energy, space, weight, and/or power requirements. When the optional step 350 is performed, the step 360 might be performed at the external processor arrangement. After the optional step 350, the step 360 will be performed.

Step 360 comprises updating a database of the pilot situational awareness system based on the provided sensor data. In one example, step 360 is only performed in case it is determined in step 240 that the provided sensor data and the corresponding data from the pilot situational awareness system differ more than a pre-determined threshold. In one example, the updating of the database of the pilot situational awareness system is performed at the external processor arrangement. In one example, the updating of the database of the pilot situational awareness system is performed aboard the aircraft. In one example, the updating is only performed based on the selected sensor data in step 320.

In a preferred example, it is assumed that the provided sensor data gives more current information than the data in the database at the pilot situational awareness system. Thus, in one example, step 360 comprises replacing data in the database of the pilot situational awareness system with the corresponding information from the provided sensor data. As an example, in case it is determined from the sensor data that the ground in an area has been paved, whereas the corresponding data from the pilot situational awareness system shows an unpaved ground, the database might be updated to paved ground in the area. As another example, in case it is determined from the sensor data that no building is in an area, whereas the corresponding data from the pilot situational awareness system shows a building, it might be concluded that the building has been destructed and the database might be updated accordingly. In one example, the database might not contain any data corresponding to the sensor data. Thus, as an example, step 360 might comprise adding sensor data to the database. It should be understood that the sensor data used for updating the database might be processed before the update is performed. As an example, the processing might comprise determining soil properties, or determining any other property from the sensor data. The processing might comprise correcting distortions, or correcting any other property of the sensor data. Methods for updating models of the environment have, for example, been developed by Vricon Systems AB. These models might, as have been described above, be used for pilot situational awareness systems. The method continues with the optional step 370.

The optional step 370 comprises transmitting an update of the database from the external processor arrangement to the aircraft. This might especially be useful in case step 350 has been performed earlier. Step 370 has the advantage that the updated database will be available at the aircraft, and thus can be used for operating the aircraft, even if the updating of the database has been performed external to the aircraft. After the optional step 370 the method 300 ends.

Above, the method 300 has been described in a specific order. It should, however, be understood that the order of the steps might be changed and/or that steps might be performed in parallel. Examples of changes in order have been discussed in relation to step 350. However, even other changes of order are possible as long as one step does not necessarily require the outcome of a previous step. As an example, step 320 and step 330 might be easily interchanged or performed in parallel.

In one embodiment, the method 300 is performed repeatedly. In one example, the updating of the pilot situational awareness system is performed in real-time or at least in nearly real-time. This has been described in more detail in relation to FIG. 2. Especially the selecting of sensor data, the updating process which is only performed in case certain conditions are fulfilled, such as differences above a certain threshold, and/or transmitting of data to external processers each might contribute to achieve a reduction in time for the updating process.

The method 300 can comprise sending the updated information to several pilot situational awareness systems.

The present disclosure also relates to a computer program product and to a computer-readable storage medium. The computer program product and the computer-readable storage medium can comprise instructions which, when the program is executed by a computer, cause the computer to carry out the method 300. As an example, the execution might be performed on the system 299 described in relation to FIG. 2, for example on the first and/or processor arrangement unit 200, 205.

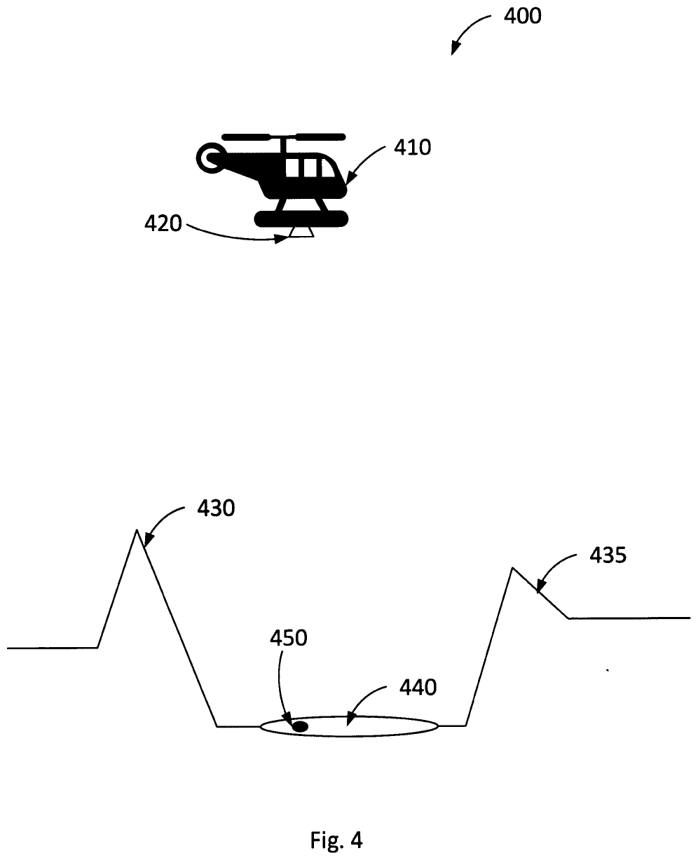

FIG. 4 shows, in a schematic way, an example of a situation 400 in which the present disclosure can be used. In this situation an aircraft, such as a helicopter 410, is equipped with a sensor, such as a camera 420 for visible light. The helicopter 410 is further equipped with a pilot situational awareness system (not shown in the figure). The pilot of the helicopter 410 might intend to land close to specific spot 450. This might, for example, be for performing a rescue mission, for example for saving an alpinist which had an accident. The spot 450 might be situated in difficult terrain, such as close to mountains 430, 435. The pilot of the helicopter 410 thus intends to find a place 440 where it is safe to land without risking of approaching the mountains 430, 435 too much and thus risking a crash of the helicopter 410. However, the pilot situational awareness system might at the beginning not contain enough information for helping the pilot to perform a safe landing and/or finding a safe place 440 to land. The pilot can then fly above the place where he intends to land so that the camera 420 can take pictures of the surrounding. Based on these pictures a database of the pilot situational awareness system can be updated with data from the camera 420. This update then provides enough information for the pilot situational awareness system so that it, for example, can guide the pilot to a safe landing and/or helping the pilot finding a safe place to land.

It should be emphasised that the situation in FIG. 4 is only very schematic. FIG. 4 is only intended to provide a better understanding of the use of the present disclosure. However, it should be understood that the present disclosure can also be applied in circumstances which differ greatly from FIG. 4.

### LIST OF ELEMENTS

100 Aircraft
200 First processor arrangement
205 Second processor arrangement
210 Pilot situational awareness system
211 SVS
212 SVGS
213 TAWS
220 Sensor array
221 Infrared sensor
222 Sensor for visible light
230 Database
240 First transmitter arrangement
245 First receiver arrangement
249 First transceiver arrangement
250 Second transmitter arrangement
255 Second receiver arrangement
259 Second transceiver arrangement
270 GNSS-receiver
299 System for updating a pilot situational awareness system

1-16. (canceled)

17. A method (300) for updating a pilot situational awareness system, the method comprising the steps of:
providing (310) sensor data from at least one non-ranging sensor aboard an aircraft for which the pilot situational awareness system is used; and
updating (360) a database of the pilot situational awareness system based on the provided sensor data.

18. The method according to claim 17, wherein the pilot situational awareness system is any of a synthetic vision system, SVS, synthetic vision guidance system, SVGS, and/or terrain awareness warning system, TAWS.

19. The method according to claim 17, further comprising the step of:
comparing (340) the provided sensor data from the at least one non-ranging sensor with corresponding data from the pilot situational awareness system for finding differences between the data,
wherein the updating is only performed in case it is determined that the provided sensor data and the corresponding data from the pilot situational awareness system differ more than a pre-determined threshold.

20. The method according to claim 17, wherein the at least one non-ranging sensor is an imaging sensor.

21. The method according to claim 17, further comprising the step of:
transmitting (350) the provided sensor data to a processor arrangement external to the aircraft,
wherein the updating of the database of the pilot situational awareness system is performed at the external processor arrangement.

22. The method according to claim 21, further comprising the step of transmitting (370) an update of the database from the external processor arrangement to the aircraft.

23. The method according to claim 17, further comprising the step of:
selecting (320) the provided sensor data according to pre-determined conditions,
wherein the updating is only performed based on the selected sensor data.

24. The method according to claim 17, wherein the updating of the pilot situational awareness system is performed in real-time or at least in nearly real-time.

25. A system (299) for updating a pilot situational awareness system (210), the system comprising:
at least one non-ranging sensor (220), being configured to provide sensor data, wherein the at least one non-ranging sensor is situated aboard an aircraft for which the pilot situational awareness (210) system is used;
the pilot situational awareness system (210); and
a processor arrangement (200; 205), being configured to update a database (230) of the pilot situational awareness system based on the provided sensor data.

26. The system according to claim 25, wherein the pilot situational awareness system (210) is any of a synthetic vision system (211), SVS, synthetic vision guidance system (212), SVGS, and/or terrain awareness warning system (213), TAWS.

27. The system according to claim 25, wherein the at least one non-ranging sensor (220) is an imaging sensor (221, 222).

28. The system according to claim 25, wherein the processor arrangement (200; 205) is at least partly situated external to the aircraft, the system further comprising a transmitter arrangement (240, 249), being arranged to transmit the provided sensor data to the external processor arrangement (205).

29. The system according to claim 28, further comprising a receiver arrangement (245, 249) aboard the aircraft, being arranged to receive an update of the database (230) from the external processor arrangement (205).

30. An aircraft (100), comprising the system (299) according to claim 25.

31. A computer program product, comprising instructions which, when the program is executed by a computer, cause the computer to carry out the method according to claim 17.

32. A computer-readable storage medium comprising instructions which, when executed by a computer, cause the computer to carry out the method according to claim 17.
